(19) United States
(12) Patent Application Publication
(10) Pub. No.: US 2020/0050814 A1
(43) Pub. Date: Feb. 13, 2020

(54) CAPACITIVE TOUCH PROXIMITY SENSING SWITCH IN A BARCODE SCANNING DEVICE

(71) Applicant: Esa Kimmo Piironen, Guilford, CT (US)

(72) Inventor: Esa Kimmo Piironen, Guilford, CT (US)

(21) Appl. No.: 16/536,115

(22) Filed: Aug. 8, 2019

Related U.S. Application Data
(60) Provisional application No. 62/715,987, filed on Aug. 8, 2018.

(51) Int. Cl. G06K 7/14

(52) U.S. Cl. CPC G06K 7/1413

(57) ABSTRACT

A barcode scanning device and a method for implementing the barcode scanning device is provided and disclosed and includes a device mounting article which defines a device cavity for securely containing a portable processing device and a device scanning article, wherein the device scanning article is communicated with the portable processing device. The barcode scanning device includes an activation button, and at least one capacitive touch sensor configured to sense when the device scanning article is being touched by a user, wherein when the activation button is engaged and the at least one capacitive touch sensor senses that the device scanning article is being touched by a user, the device scanning article is configured to optically interact with a barcode to obtain barcode information and communicate the barcode information to the portable processing device.

### RELATED APPLICATIONS

This application claims the benefit of priority of U.S. Provisional Patent Application Ser. No. 62/715,987 (Atty. Docket No. SWB-0001-P), filed Aug. 8, 2018, the contents of which are incorporated by reference herein in its entirety.

### FIELD OF THE INVENTION

The present invention relates generally to handheld barcode scanning devices and more particularly to a handheld barcode scanning device that combines a smart phone and/or tablet with a barcode scanning device that incorporates a capacitive touch proximity sensing capability for operation and safety.

### BACKGROUND OF THE INVENTION

A barcode is an optically configured, machine-readable representation of data which includes information about a specific topic, such as an object. As is known, there are many different types of barcodes used to represent information and they include a one-dimensional (1D) barcode, a two-dimensional (2D) barcode and a Quick Response (QR) code. Barcodes have a large number of uses and are typically used to receive and convey information and/or identify and track objects in many different types of industry including grocery stores, healthcare/hospitals, factories, shipping and entertainment. The barcode is presented to a barcode reading device which ‘reads’ the barcode (either by measuring ambient light or reflection) and obtains the information stored in the barcode.

There are several different types of barcode readers available and they include fixed barcode readers and handheld barcode readers. A fixed barcode reader is typically a non-portable reader that requires a user to place a barcode in a certain location/position so that the barcode reader can ‘read’ the barcode and obtain the information. A handheld barcode scanner is a battery powered portable barcode scanner that is carried by a user and allows the user to place the barcode reader in a position to read a barcode that is associated with an object. Handheld barcode readers are typically used to take inventory in a factory and or grocery store. As smart phone (PDA) and tablet technology has advanced, these devices now include sophisticated optics and the processing power of a computer. As such, applications were created that allowed users to begin using these smart phones as barcode scanning devices.

However, smart phones/tablets are not yet advanced enough for manufacturers to use them for barcode reading reliably and consistently in industry without added technology. For applications that require the use of a laser light to ‘read’ a barcode, a smart phone/tablet simply cannot be used. Additionally, if the barcode is broken, shiny or placed on a curved surface, the cameras on smart phones will not work accurately. One way that this deficiency was addressed was that a sleeve/housing was developed that would contain a smart phone and that would emit a laser light that can then be used to sense and decode a barcode. The housing would then obtain the information from the barcode and communicate the information to the smart phone for storage and/or processing.

Unfortunately, there are at least three deficiencies with the current art of barcode scanners that work with smart phones/tablets. First, the electronics in the scanner housing typically use a large amount of power relative to the batteries contained in the housing and/or the smart phone/tablet. Moreover, the runtime performance in smart phones/tablets is limited if multiple radio networks are used, such as a telecom and data network, Bluetooth®, Wifi, Near Field Communications (NFC) or GPS. This is because the use of all of these networks combined also consume a substantial amount of power. This is undesirable because the batteries then have to be recharged and/or changed often thereby increasing costs. The second deficiency with the current art of barcode scanners that work with smart phones/tablets is that the scanner is operated by a pressure or push button. Unfortunately, the most common service issue with the portable battery powered sleeve/housing is that these pressure or push buttons are broken. This is undesirable because this requires that the sleeve/housing be repaired or replaced regularly, thereby also increasing costs. The third deficiency with the current art of barcode scanners that work with smart phones/tablets involves secure data transfer. The current art uses Bluetooth® communication for data transfer between the smart phone/tablet and the host device. This is undesirable due to the deficiencies in security of data transfer using Bluetooth® devices.

### SUMMARY OF THE INVENTION

A barcode scanning device is provided and disclosed and includes a device mounting article having a mounting front portion and a mounting rear portion, wherein the mounting front portion and mounting rear portion define a device cavity for securely containing a portable processing device. The barcode scanning device also includes a device scanning article, wherein the device scanning article defines a sensor cavity and includes, a sensing device, a sensor opening, a transmitter, a receiver, an activation button, a BCS processing device, and at least one capacitive touch sensor configured to sense when the device scanning article is being touched by a user, wherein when the activation button is engaged and the at least one capacitive touch sensor senses that the device scanning article is being touched by a user, the device scanning article is configured to optically interact with a barcode having barcode information to obtain the barcode information and communicate the barcode information to the portable processing device.

A barcode scanning device is provided and disclosed and includes a device mounting article which defines a device cavity for securely containing a portable processing device and a device scanning article, wherein the device scanning article is communicated with the portable processing device. The barcode scanning device includes an activation button, and at least one capacitive touch sensor configured to sense when the device scanning article is being touched by a user, wherein when the activation button is engaged and the at least one capacitive touch sensor senses that the device scanning article is being touched by a user, the device scanning article is configured to optically interact with a barcode to obtain barcode information and communicate the barcode information to the portable processing device.

A method for implementing a barcode scanning device, wherein the barcode scanning device includes an activation button and at least one capacitive touch sensor configured to sense when the device scanning article is being touched by a user and wherein the barcode scanning device is configured to operate only when the activation button is engaged and when the at least one capacitive touch sensor senses that the device scanning article is being touched by the user is provided and disclosed wherein the method includes associating a portable processing device with the barcode scanning device, handling the portable processing device to cause the capacitive touch sensor to sense the user, engaging the activation button to cause the barcode scanning device to sense a barcode having barcode information and to obtain the barcode information and communicating the barcode information to the portable processing device.

### BRIEF DESCRIPTION OF THE DRAWINGS

The foregoing and other features and advantages of the present invention should be more fully understood from the accompanying detailed description of illustrative embodiments taken in conjunction with the following Figures in which like elements are numbered alike in the several Figures:

FIG. 1 shows a top down bottom side isometric view of a barcode scanning device having capacitive touch sensors, in accordance with one embodiment of the invention.

FIG. 2 shows a top down bottom side isometric view of the barcode scanning device having capacitive touch sensors of FIG. 1.

FIG. 3 shows a side view of the barcode scanning device of FIG. 1.

FIG. 4 shows a rear view of the barcode scanning device of FIG. 1.

FIG. 5 shows a front view of the barcode scanning device of FIG. 1.

FIG. 6 shows a side view of the barcode scanning device of FIG. 1.

FIG. 7 shows a top down view of the barcode scanning device of FIG. 1.

FIG. 8 shows a bottom up view of the barcode scanning device of FIG. 1.

FIG. 9 shows a rear side perspective view of the barcode scanning device of FIG. 1.

FIG. 10 shows a top down view of the device scanning portion of the barcode scanning device of FIG. 1, in accordance with one embodiment of the invention.

FIG. 11 shows a top down view of the device scanning portion of the barcode scanning device of FIG. 1, in accordance with one embodiment of the invention.

FIG. 12 shows a side sectional view of the device mounting portion and the device scanning portion of the barcode scanning device of FIG. 1, in accordance with one embodiment of the invention.

FIG. 13 shows a front sectional view of the device mounting portion of the barcode scanning device of FIG. 1 having a smart phone associated therewith

FIG. 14 shows a front perspective view of the barcode scanning device of FIG. 1 with the processing device contained therein

FIG. 15 shows a front top down, side exploded view of a barcode scanning device, in accordance with one embodiment of the invention.

FIG. 16 shows a rear bottom up, side exploded view of the barcode scanning device of FIG. 15.

FIG. 17 shows a top down front side perspective view of a processing device for use with the barcode scanning device of FIG. 15, in accordance with one embodiment of the invention.

FIG. 18 shows a top down rear side perspective view of the processing device of FIG. 17.

FIG. 19 shows a front top down, side exploded view of the barcode scanning device of FIG. 15 with the processing device of FIG. 17 with the device scanning portion mounted length wise, in accordance with one embodiment of the invention.

FIG. 20A shows a rear bottom up, side exploded view of the barcode scanning device of FIG. 15 associated with the processing device of FIG. 17 with the device scanning portion mounted length wise, in accordance with one embodiment of the invention.

FIG. 20B shows a top down view of the device scanning portion of the barcode scanning device of FIG. 15 and FIG. 19, in accordance with one embodiment of the invention.

FIG. 21 shows a rear top down, side view of the barcode scanning device of FIG. 15 associated with the processing device of FIG. 17, in accordance with one embodiment of the invention.

FIG. 22 shows a rear bottom up, side view of the barcode scanning device of FIG. 15 associated with the processing device of FIG. 17, in accordance with one embodiment of the invention.

FIG. 23 shows a front top down, side view of the barcode scanning device of FIG. 15 associated with the processing device of FIG. 17, in accordance with one embodiment of the invention.

FIG. 24 shows a front bottom up, side view of the barcode scanning device of FIG. 15 associated with the processing device of FIG. 17, in accordance with one embodiment of the invention.

FIG. 25 shows a rear, side exploded view of the barcode scanning device of FIG. 20 with the processing device of FIG. 17, with the device scanning portion mounted width wise, in accordance with one embodiment of the invention.

FIG. 26 shows a rear, top down, side view of the barcode scanning device of FIG. 25 associated with the processing device of FIG. 17, in accordance with one embodiment of the invention.

FIG. 27 shows a rear, bottom up, side view of the barcode scanning device of FIG. 25 associated with the processing device of FIG. 17, in accordance with one embodiment of the invention.

FIG. 28 shows a front, top down, side view of the barcode scanning device of FIG. 25 associated with the processing device of FIG. 17, in accordance with one embodiment of the invention.

FIG. 29 shows a front, bottom up, side view of the barcode scanning device of FIG. 25 associated with the processing device of FIG. 17, in accordance with one embodiment of the invention.

FIG. 30 shows a top down, side view of a cradle device for use with the barcode scanning device of FIG. 15 and FIG. 25 with the processing device of FIG. 17, in accordance with one embodiment of the invention.

FIG. 31 shows a bottom side view of the cradle device of FIG. 30.

FIG. 32 shows a front, top down view of a plurality of cradle devices of FIG. 30 associated together in a cradle nesting device, in accordance with one embodiment of the invention.

FIG. 33 shows a front, exploded view of the barcode scanning device of FIG. 19, the cradle device of FIG. 30 and the nesting device of FIG. 32, in accordance with one embodiment of the invention.

FIG. 34 shows a front, exploded view of the barcode scanning device of FIG. 25, the cradle device of FIG. 30 and the nesting device of FIG. 32, in accordance with one embodiment of the invention.

FIG. 35 shows a top down front view of the barcode scanning device of FIG. 25 located within the cradle device and nesting device of FIG. 34, in accordance with one embodiment of the invention.

FIG. 36 shows a top down rear view of the barcode scanning device of FIG. 25 located within the cradle device and nesting device of FIG. 34, in accordance with one embodiment of the invention.

### DETAILED DESCRIPTION

As discussed hereinafter and in accordance with the present invention, a barcode scanning device is provided for use with a portable processing device (such as, for example, a smart phone, tablet, iPhone®, iPad®, iPod® Touch, etc.) wherein the barcode scanning device includes a capacitive touch sensor to sense contact with a human hand and allow operation. The barcode scanning device may be configured as a sleeve/housing to contain the portable processing device for operation, wherein the barcode scanning device is connected to the portable processing device and may include a battery that may act as a power source. As such, once the power level on the portable processing device drops below a predetermined level (say for example, 25%), the barcode scanning device may provide extra power to the portable processing device. This may almost double the runtime of the portable processing device while scanning of barcodes is taking place. Additionally, the barcode scanning device is a portable, battery powered sleeve/housing that includes a scanning device with an imager camera and that contains the portable processing device and that would emit a laser light that can then be used to sense and decode a barcode. It should be appreciated that the imager camera may be configured to read any type of barcode suitable to the desired end purpose (for example 1D, 2D and/or 3D barcodes), such as a 2-dimensional imager camera. It should be further appreciated that communication between the processing device (i.e. smart phone/tablet) is accomplished via a secure wireless and/or hardwired connection, such as USB, Apple® Lighting Connector or any other connection suitable to the desired end purpose.

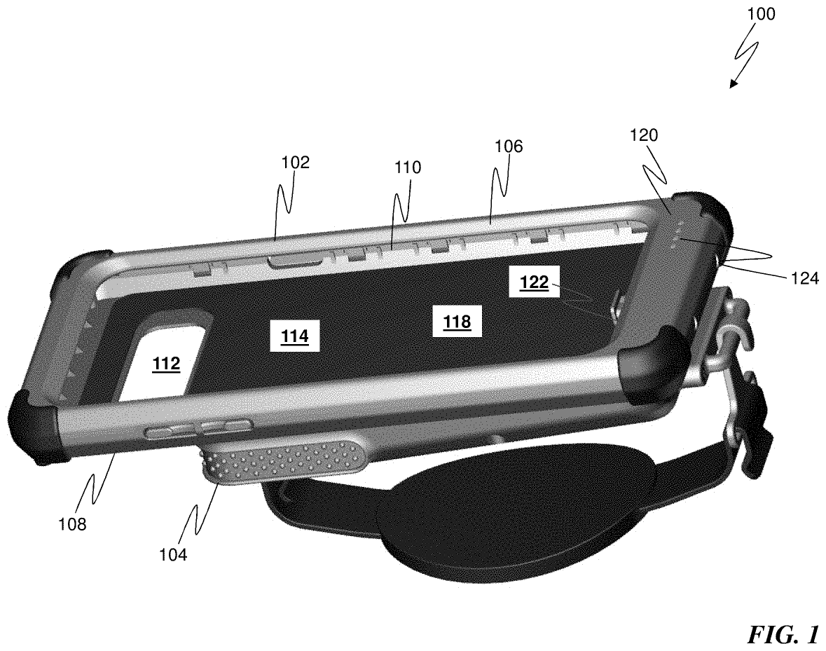

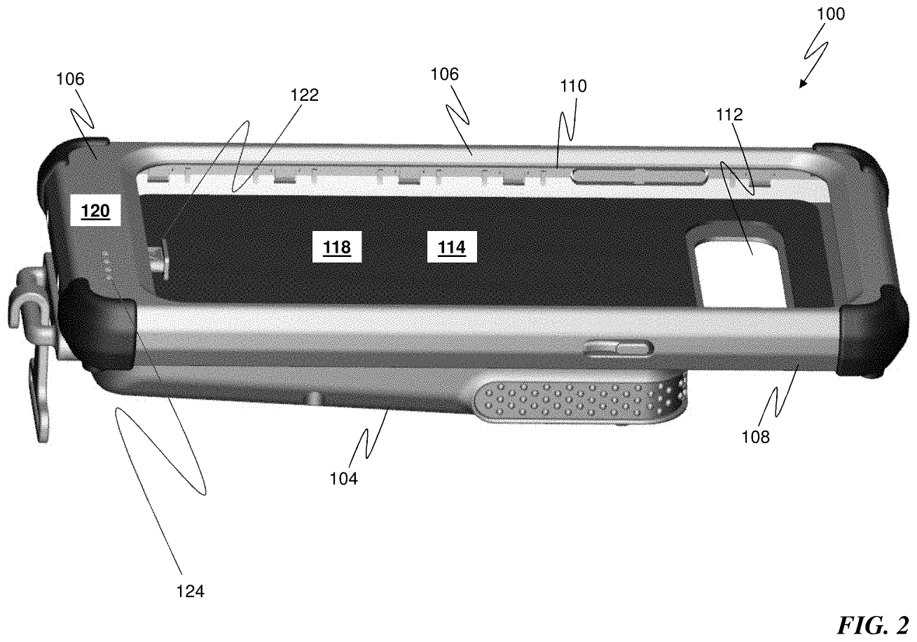

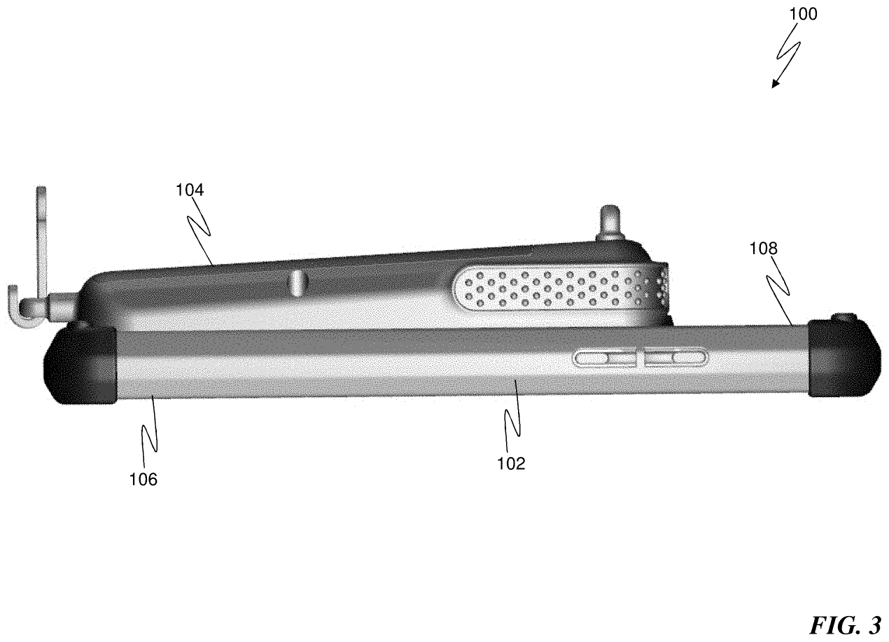

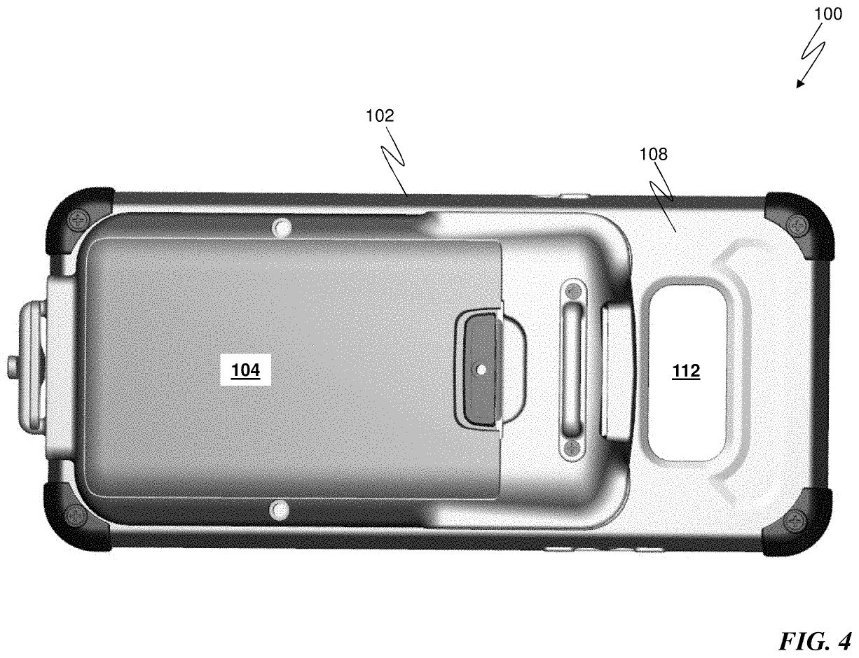

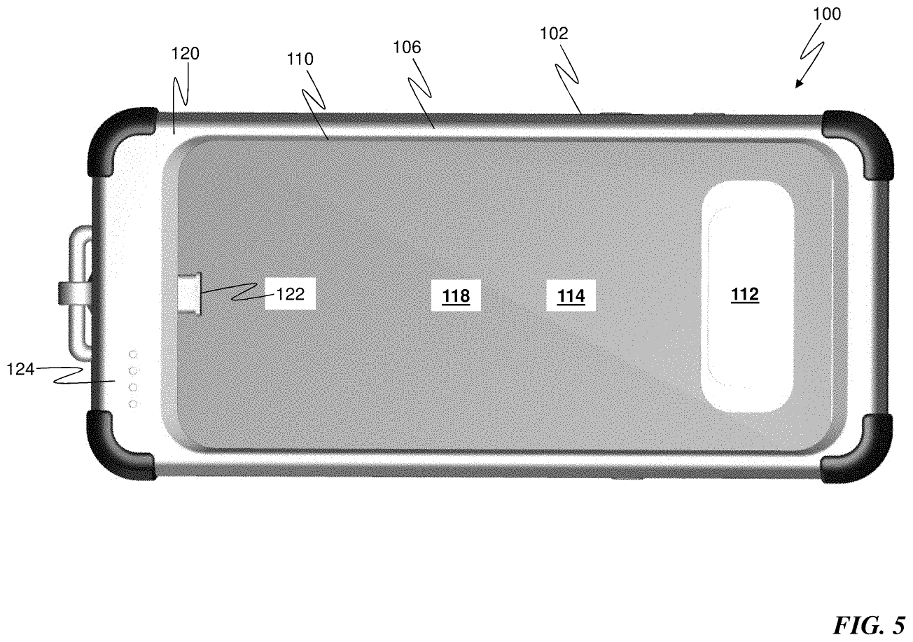

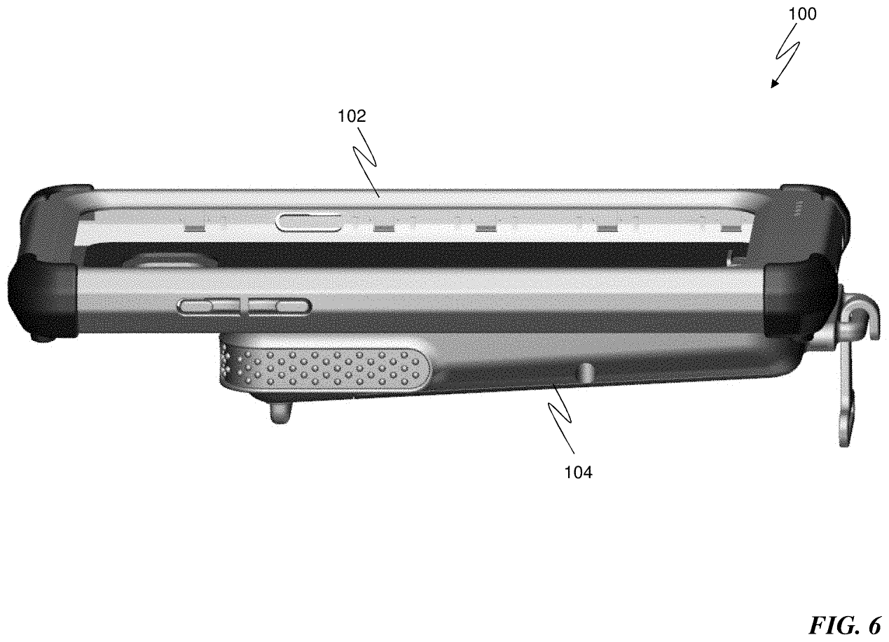

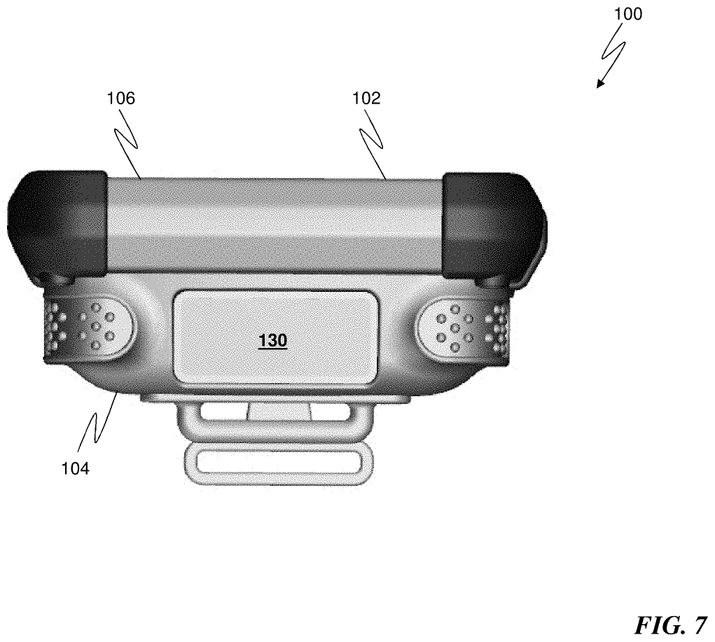

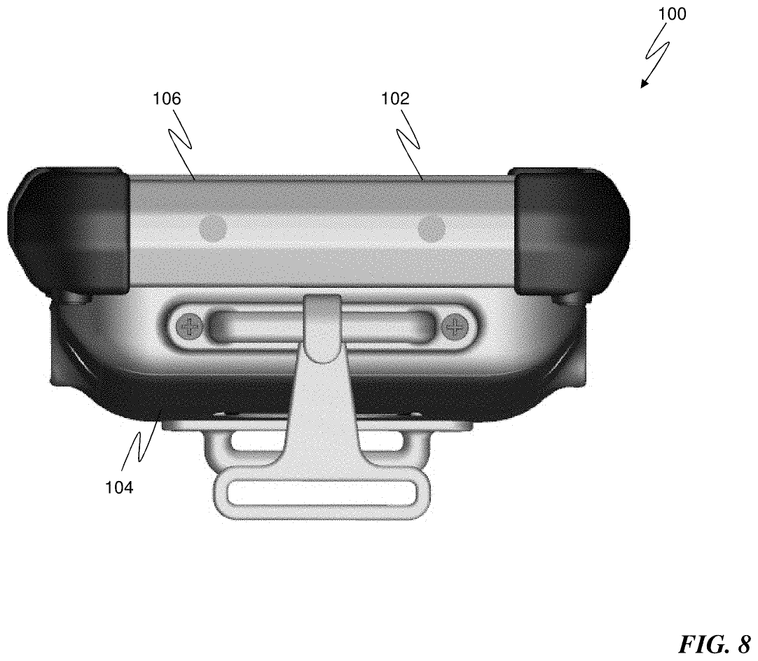

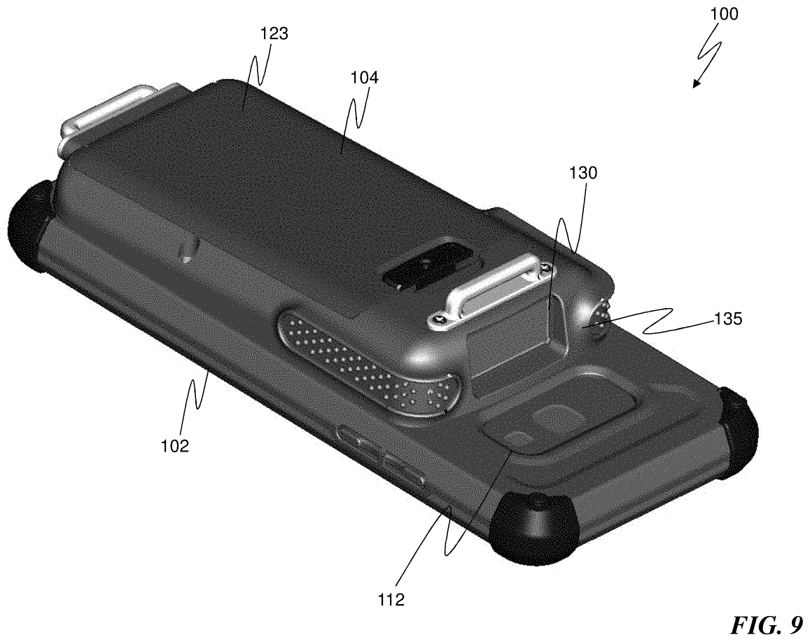

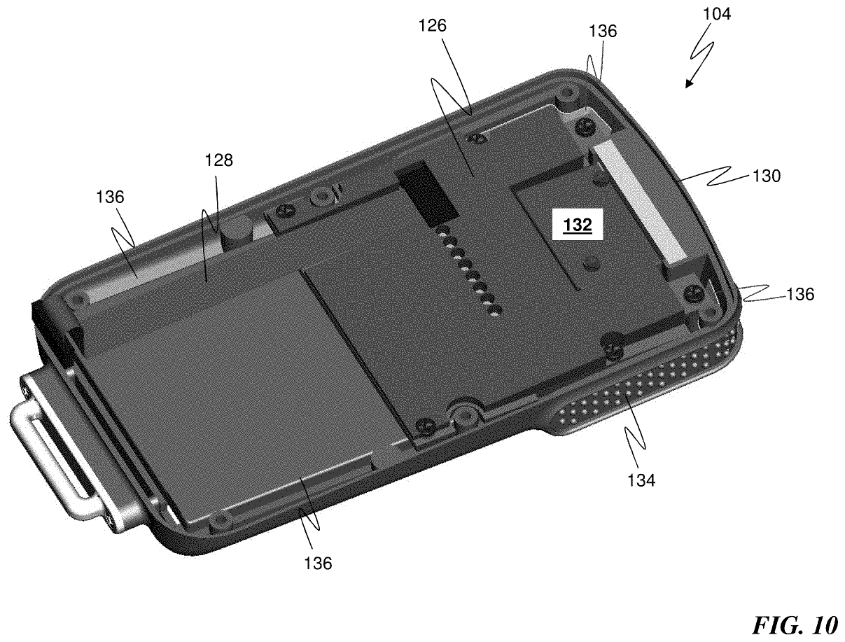

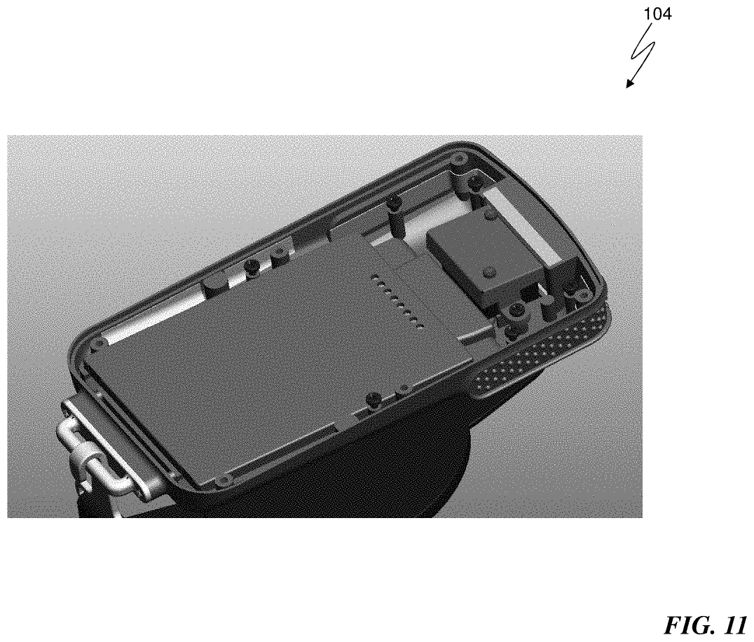

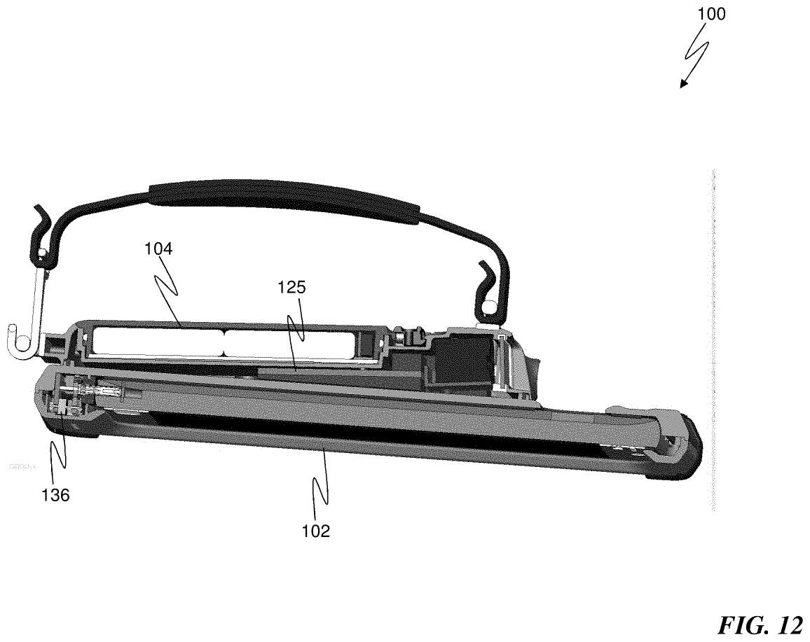

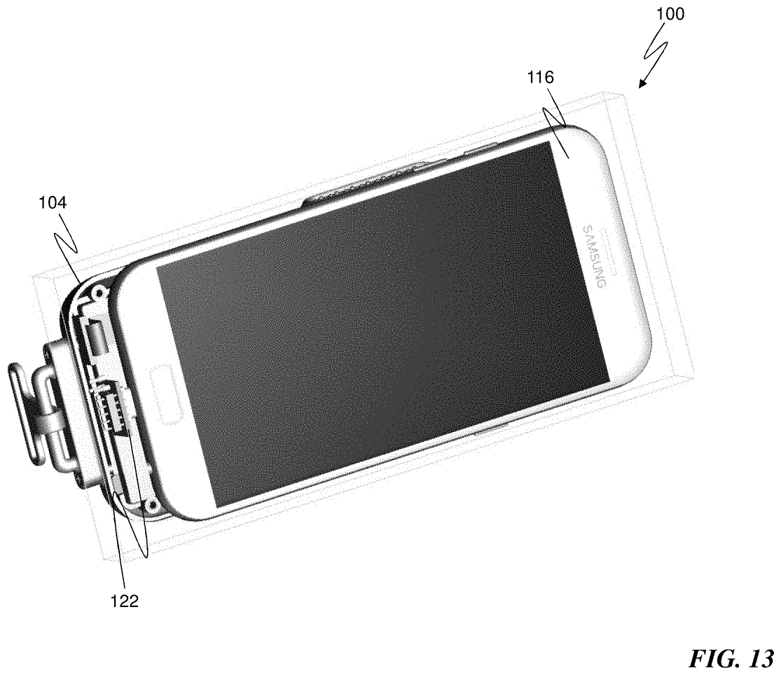

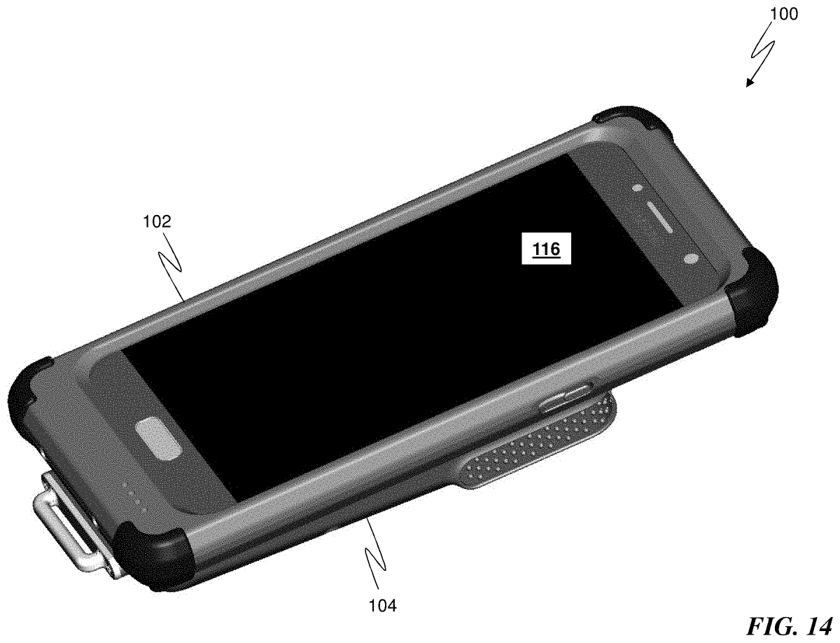

Referring to FIGS. 1-14, a barcode scanning device 100 configured to operate with a smart phone is shown in accordance with one embodiment of the invention and includes a device mounting portion 102 and a device scanning portion 104. The device mounting portion 102 includes a mounting front portion 106 and a mounting rear portion 108, wherein the mounting front portion 106 is removably connected to the mounting rear portion 108. It should be appreciated that the mounting front portion 106 defines a front opening 110 and the mounting rear portion 108 defines a rear opening 112. Moreover, the combination of the mounting front portion 106 and the mounting rear portion 108 defines a device cavity 114 for containing a processing device 116, wherein the front opening 110 and rear opening 112 are communicated with the device cavity 114 to allow access to the processing device 116 when the processing device 116 is located within the device cavity 114. Although it is contemplated that in an exemplary embodiment the processing device 116 may be a smart phone (such as a Samsung S8 or an iPhone®), it should be appreciated that the processing device 116 may be any processing device suitable to the desired end purpose. The device mounting portion 102 further includes a mounting portion inner surface 118, a mounting portion outer surface 120, a device connector 122 and a sensor portion 124.

The device scanning portion 104 includes a sensing device 126 and defines sensor cavity 128 having a sensor opening 130, wherein the sensing device 126 includes a sensing device transmitter/receiver 132 and is located within the sensor cavity 128 such that the sensor opening 130 is communicated with the sensing device transmitter/receiver 132. The device scanning portion 104 further includes at least one sensor button/touch area 134 located on at least one side of the device scanning portion 104. It should be appreciated that the at least one sensor button/touch area 134 is associated with the sensing device 126 such that the sensing device 126 is operable by engaging/disengaging the at least one sensor button/touch area 134. It should also be appreciated that the at least one sensor button/touch area 134 may be any type of button/switching device configuration suitable to the desired end purpose, such as capacitive touch sensing button/touch area, a compression button, a switch, etc. As such, in one embodiment, the device scanning portion 104 may include both a capacitive touch sensing button/touch area 134 and a compression button.

Additionally, in one embodiment, the at least one sensor button/touch area 134 may be curved to allow users with larger hands/fingers to grip, hold and/or activate the barcode scanning device 100 more easily. Moreover, in one embodiment, the device scanning portion 104 may include a touch area lip 135 located at one end of at least one sensor button/touch area 134. This lip 135 allows for proper finger placement during use and helps to prevent the fingers from extending past the end of the at least one sensor button/touch area 134 and covering or blocking the sensor opening 130 and/or the sensing device transmitter/receiver 132.

Furthermore, the barcode scanning device 100 includes several capacitive touch sensors 136 located to sense that a human hand is holding the barcode scanning device 100 is the scanning position. It should be appreciated that although the present invention is described herein as incorporating more than one capacitive touch sensor 136, it is contemplated that the invention may use one or more capacitive touch sensors 136 as desired. In the present invention, it should be appreciated that the barcode scanning device 100 includes capacitive touch sensors 136 located proximate the at least one sensor button/touch area 134 on the device scanning portion 104, located on one or more sides of the sensor cavity 128 and/or on the mounting front portion 106 of the device mounting portion 102. The capacitive touch sensor 136 located on the mounting front portion 106 is configured to activate the sensor portion 124 located proximate the mounting front portion 106 of the device mounting portion 102. Moreover, the capacitive touch sensors 136 located proximate the at least one sensor button/touch area 134 on the device scanning portion 104 and on one or more sides of the sensor cavity 128 are configured to activate the sensing device 126. Because the capacitive touch sensor 136 needs to be touching and/or proximate to the hand or fingers of a user, this advantageously requires the barcode scanning device 100 to be held in hand to prevent the barcode scanning device 100 from being inadvertently operated.

Additionally, the barcode scanning device 100 may include a battery 123 and a BCS processing device 125 that is configured to monitor and/or sense characteristics of the processing device 116. For example, the BCS processing device 125 may sense the battery level of the processing device 116 and when the processing device 116 battery level falls below a predetermined level (for example, 25%), the BSC processing device 125 may provide extra power to the processing device 116 using the barcode scanning device battery 123. It should be appreciated that the barcode scanning device battery 123 is connected to the processing device 116 (smart phone) via a USB port on the processing device 116. This USB connection also allows the barcode scanning device 100 to communicate with the processing device 116.

It should be further appreciated that the device connector 122 is in electrical connection with the sensing device 126 and is configured to physically connect with the processing device 116 when the processing device 116 is located within the device cavity 114 such that the processing device 116 and the sensing device 126 are in electrical/signal communication. Accordingly, when the processing device 116 is located within the device cavity 114 and a user engages the at least one sensor button/touch area 134, the sensing device 126 emits laser light from the sensor opening 130. When the laser light contacts a barcode, the sensing device 126 ‘senses’ the barcode, obtains information from the barcode and communicates the information from the barcode to the processing device 116.

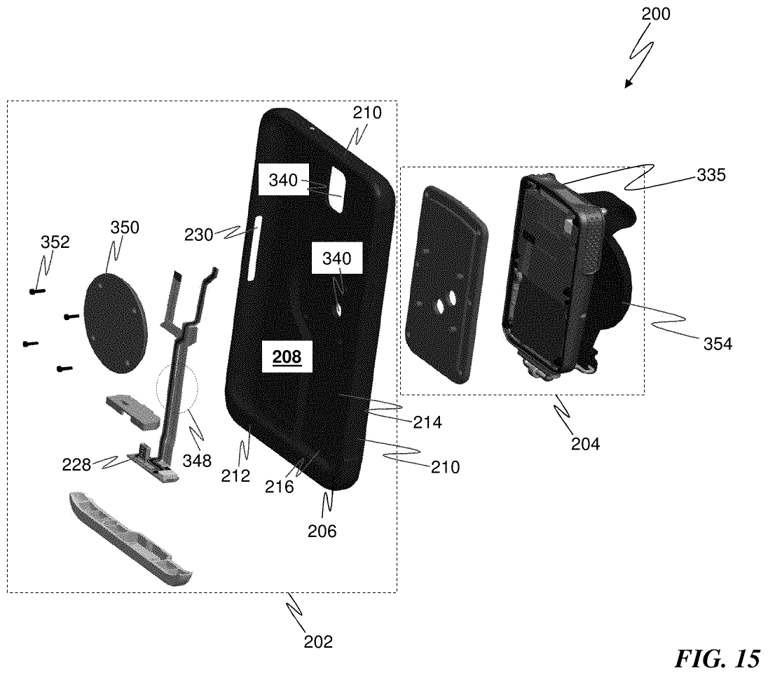

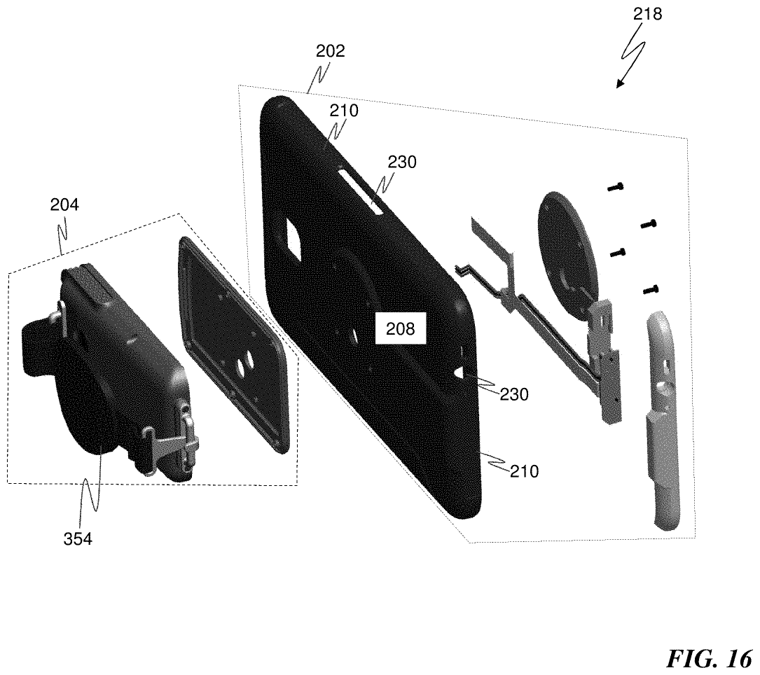

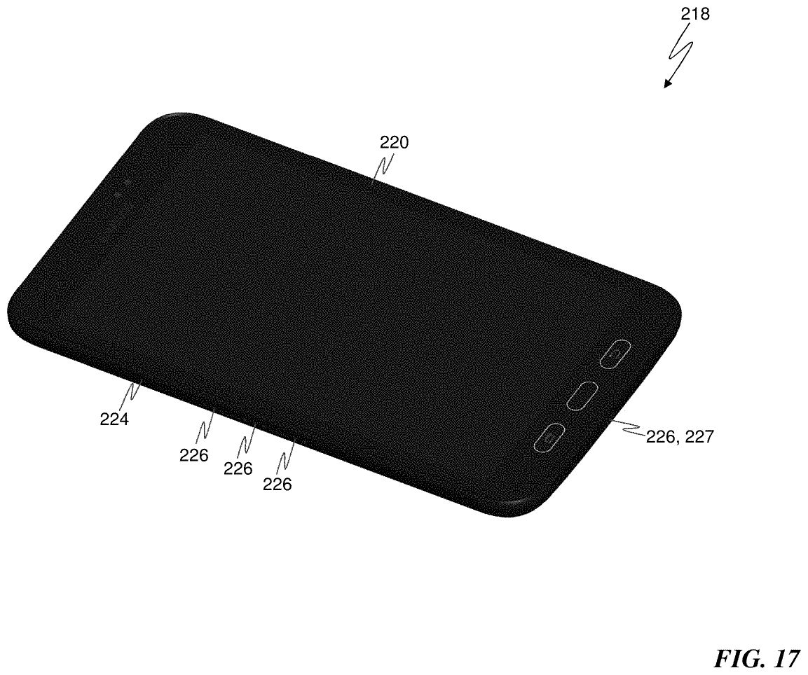

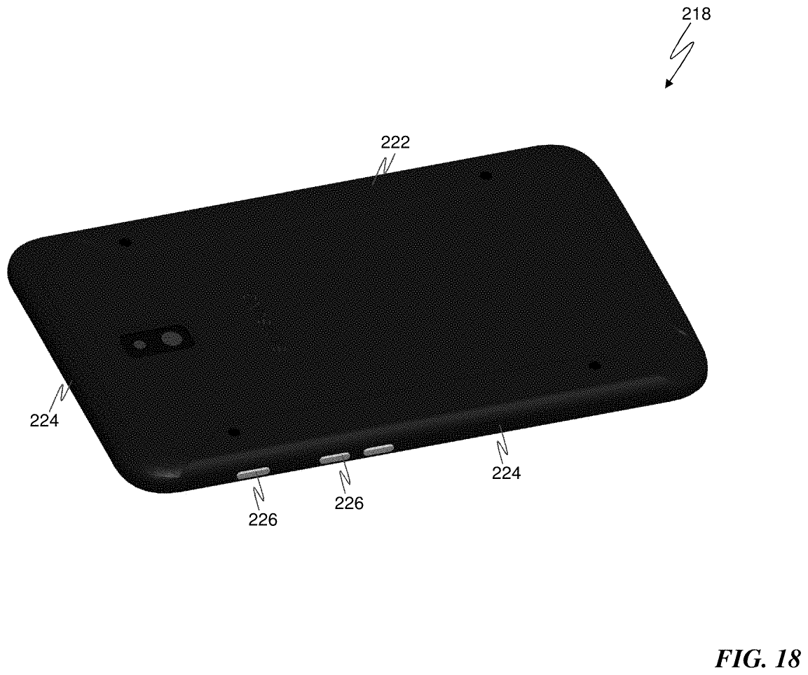

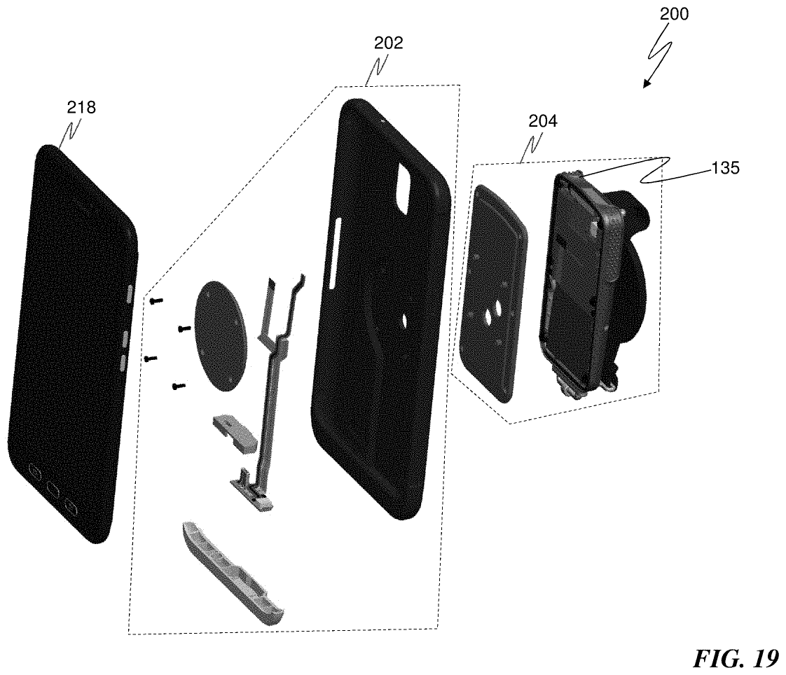

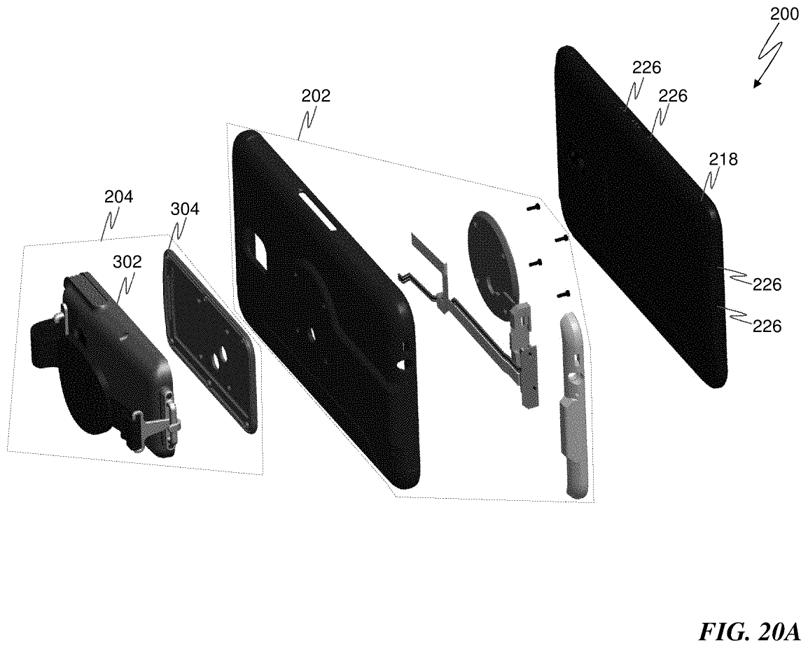

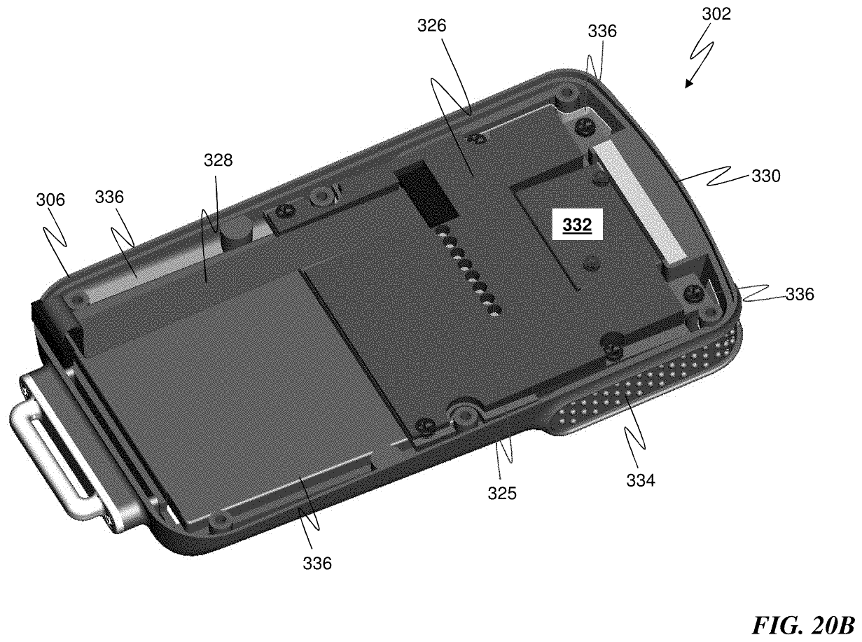

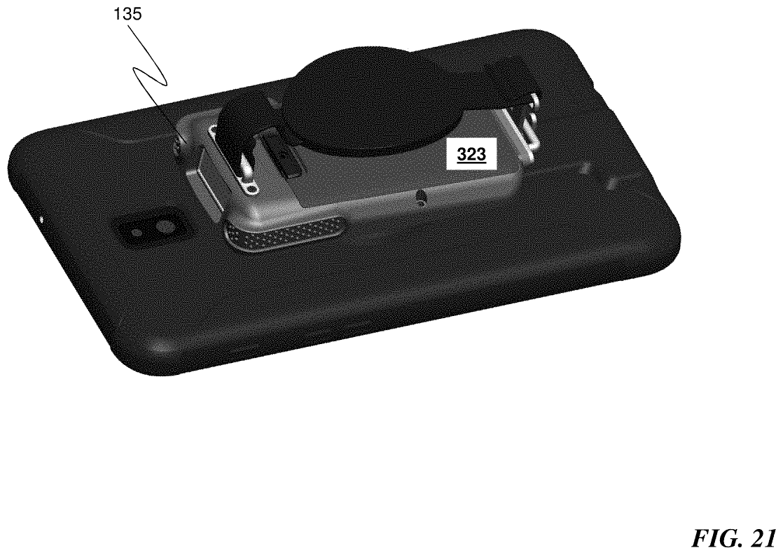

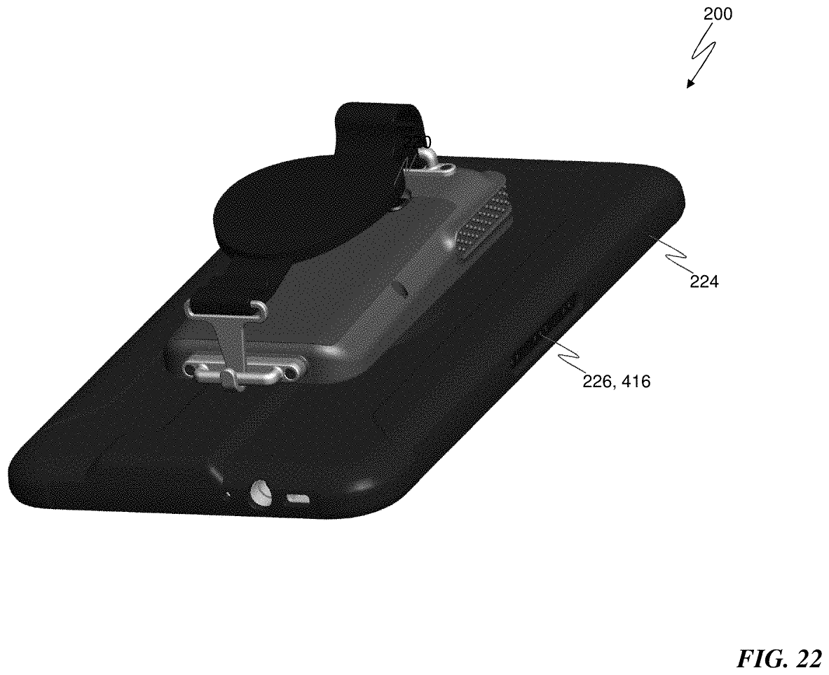

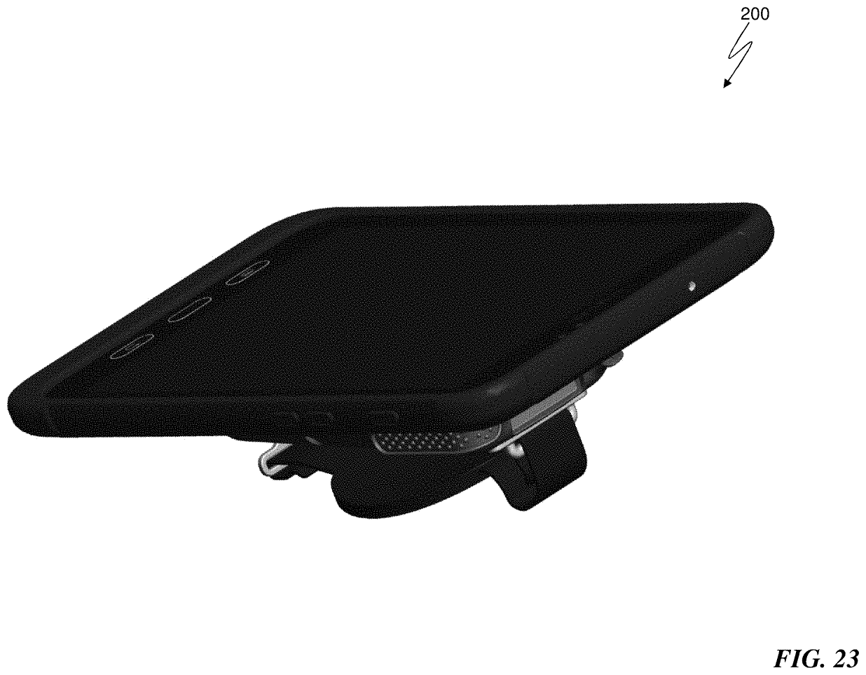

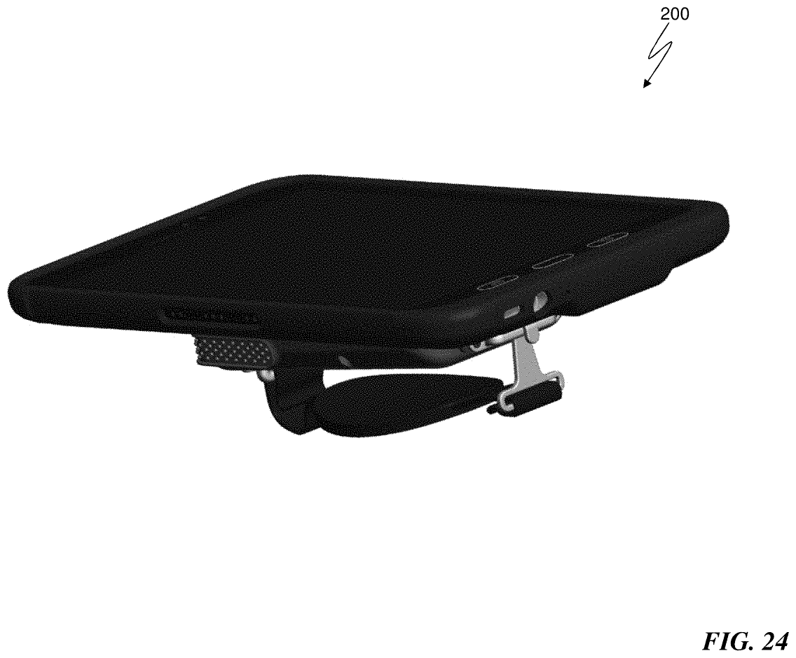

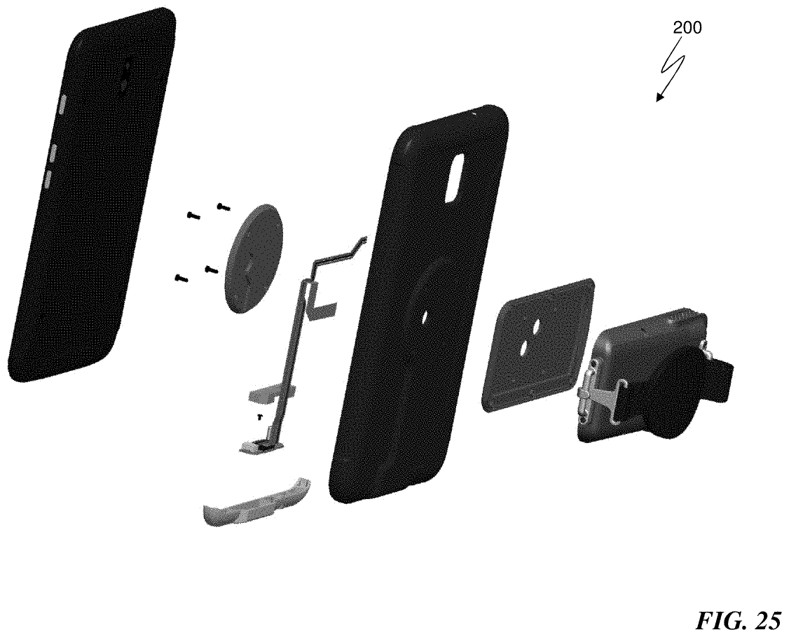

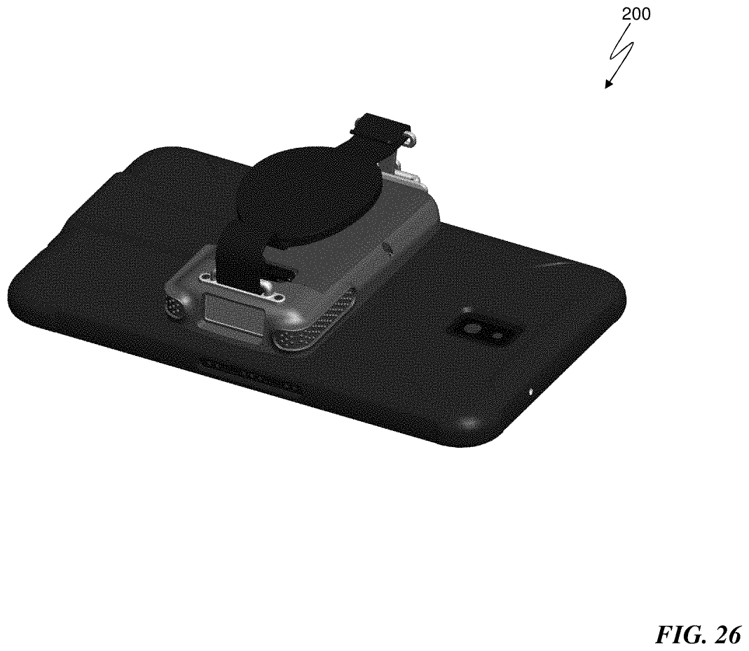

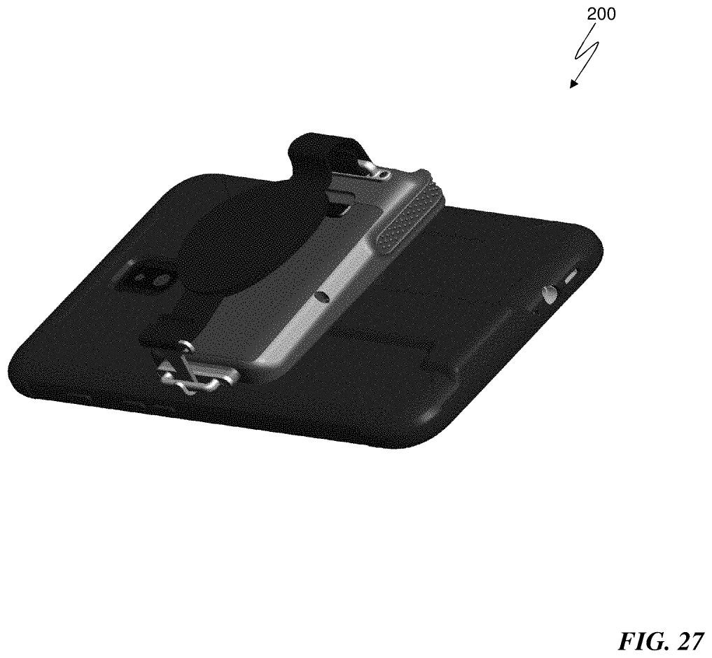

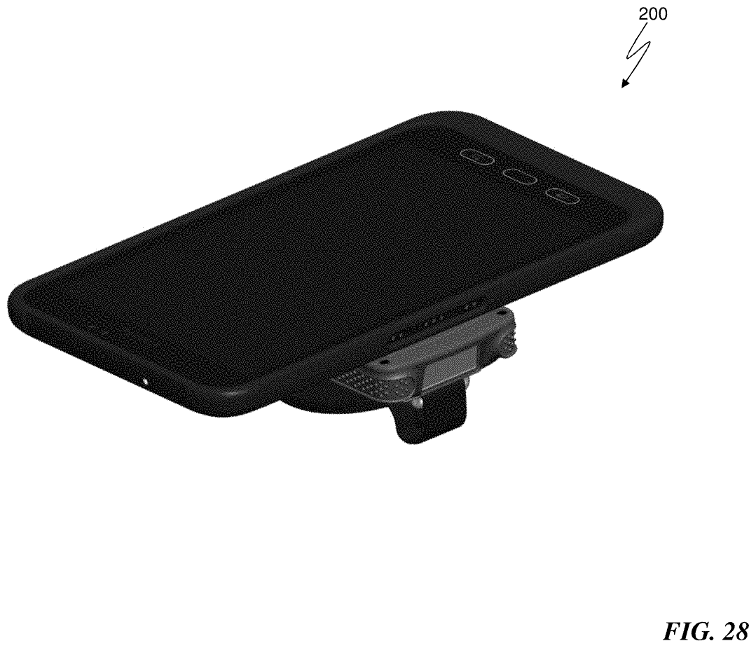

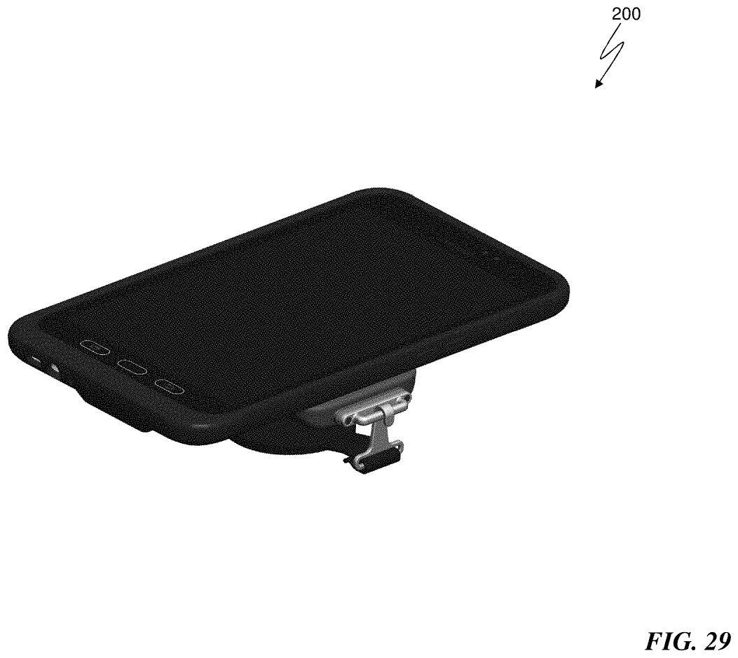

Referring to FIGS. 15-29, a barcode scanning device 200 configured to operate with a tablet and/or laptop device is shown in accordance with another embodiment of the invention and includes a device mounting portion 202 and a device scanning portion 204. The device mounting portion 202 includes a mounting portion structure 206 which includes a mounting portion rear 208, mounting portion sides 210 and a mounting portion front 212, wherein the mounting portion front 212 defines a mounting portion front opening 214 and wherein the mounting portion rear 208 defines one or more mounting portion rear openings 340. Additionally, the mounting portion rear 208, mounting portion sides 210 and mounting portion front 212 define a mounting portion structure cavity 216 for securely containing a processing device 218 (such as a tablet and/or laptop), wherein the processing device 218 includes a processing device front 220, a processing device rear 222 and four (4) processing device sides 224.

It should be appreciated that the processing device 218 may further include one or more electrical and/or signal connectors and buttons 226 located on one or more of the four (4) processing device sides 224. The device mounting portion 202 further includes a mounting portion processor connector 228 which is securely located within the mounting portion structure cavity 216 and which is configured to connect to the processing device 218. It should be appreciated that, in one embodiment, the mounting portion processor connector 228 may include a USB connector (or other suitable connector such as Apple® Lightning connector) to connect with the processing device 218 via the USB port 226, 227(or other suitable connector such as Apple® Lightning connector port) of the processing device 218. Thus, when the processing device 218 is securely located within the mounting portion structure cavity 216, the mounting portion processor connector 228 is physically connected to the processing device 218 via one of the one or more electrical and/or signal connectors 226 (such as USB connector 227).

It should be appreciated that in this embodiment, the mounting portion structure 206 is shown as being configured as a single piece structure which may be wholly or partially constructed from a flexible material (such as a plastic material, rubber material, composite material and/or a combination thereof) to fit over the processing device 218 in a glove like fashion. However, in other embodiments, it is contemplated that the mounting portion structure 206 may be configured in multiple pieces (such as the device mounting portion 102) and may be wholly or partially constructed from a rigid and/or semi-rigid (such as a plastic material, a rubber material, a metal material, a composite material and/or a combination thereof). Moreover, the mounting portion sides 210 may define one or more side openings 230, wherein the one or more side openings 230 may be configured to coincide with processing device connectors and/or processing device connectors and buttons 226 located on the sides 224 of the processing device 218. This advantageously allows the mounting portion structure 206 to have a general configuration to allow operation with any processing device 218 or to be configured specifically for different processing devices 218 as desired, such as a laptop, a tablet, an iPhone®, an iPad®, an iPod® Touch, etc.

The device scanning portion 204 includes a scanning device body 302 and a scanning device body cover 304, wherein the scanning device body 302 defines a sensor cavity 328, a scanning device body opening 306 and a sensor opening 330, wherein the scanning device body opening 306 and sensor opening 330 are communicated with the sensor cavity 328. The scanning device body cover 304 is configured to be securely and/or removably associated with the scanning device body 302 to cover the scanning device body opening 306, such as via by screws. The device scanning portion 204 further includes a sensing device 326 which is located within the sensor cavity 328, wherein the sensing device 326 includes a sensing device transmitter/receiver 332 and is located within the sensor cavity 328 such that the sensor opening 330 is communicated with the sensing device transmitter/receiver 332.

Additionally, the scanning device portion 204 may include a replaceable and/or rechargeable battery 323 and a BCS processing device 325 that is configured to monitor and/or sense characteristics of the processing device 218, wherein the BCS processing device 325 is located within the sensor cavity 328. For example, the BCS processing device 325 may sense the battery level of the processing device 218 and when the processing device 218 battery level falls below a predetermined level (for example, 25%), the BSC processing device 325 may provide extra power to the processing device 218 using the barcode scanning device battery 323. It should be appreciated that the scanning device body cover 304 may include one or more body cover openings 308 to allow one or more components of the device scanning portion 204 (such as, for example the BCS processing device 325 and/or the battery 323) to be in electrical and/or signal connection with the mounting portion processor connector 228. This may be accomplished via wires that connect the scanning device portion 204 with the mounting portion processor connector 228 via the one or more body cover openings 308 and the one or more mounting portion rear openings 340.

The device scanning portion 304 further includes at least one sensor button/touch area 334 located on at least one side of the device scanning portion 304. It should be appreciated that the at least one sensor button/touch area 334 is associated with the sensing device 326 such that the sensing device 326 is operable by engaging/disengaging the at least one sensor button/touch area 334. It should also be appreciated that the at least one sensor button/touch area 334 may be any type of button/switching device configuration suitable to the desired end purpose, such as capacitive touch sensing button/touch area, a compression button, a switch, etc. As such, in one embodiment, the device scanning portion 304 may include both a capacitive touch sensing button/touch area 334 and a compression button.

Moreover, in one embodiment, the at least one sensor button/touch area 334 may be curved to allow users with larger hands/fingers to grip, hold and/or activate the barcode scanning device 200 more easily. Moreover, in one embodiment, the device scanning portion 304 may include a touch area lip 335 located at one end of at least one sensor button/touch area 334. This lip 335 allows for proper finger placement during use and helps to prevent the fingers from extending past the end of the at least one sensor button/touch area 334 and covering or blocking the sensor opening 330 and/or the sensing device transmitter/receiver 332.

Furthermore, the barcode scanning device 200 may include several capacitive touch sensors 336 located to sense that a human hand is holding the barcode scanning device 200 in the scanning position. It should be appreciated that although the present invention is described herein as incorporating more than one capacitive touch sensor 336, it is contemplated that the invention may use one or more capacitive touch sensors 336 as desired. In one embodiment of the invention, the barcode scanning device 200 may include capacitive touch sensors 336 located proximate the at least one sensor button/touch area 334 on the device scanning portion 204, located on one or more sides of the sensor cavity 328 and/or on the mounting portion front 212 of the device mounting portion 202. Thus, if there is a capacitive touch sensor 336 located on the mounting portion front 212, the capacitive touch sensor 336 may be configured to activate the sensor portion 324 located proximate the mounting portion front 212 of the device mounting portion 202. Moreover, the capacitive touch sensors 336 located proximate the at least one sensor button/touch area 334 on the device scanning portion 204 and on one or more sides of the sensor cavity 328 are configured to activate the sensing device 326. Because the capacitive touch sensor 336 needs to be touching and/or proximate to the hand or fingers of a user, this advantageously requires the barcode scanning device 200 to be held in hand to prevent the barcode scanning device 200 from being inadvertently operated.

It should be appreciated that the present invention allows the device mounting portion 202 and the device scanning portion 204 to be securely connected to each other and thus, allows the device scanning portion 204 to be in electrical and/or signal connection with the processing device 218. Thus, the mounting portion processor connector 228 is in electrical connection with the sensing device 326 and is configured to physically connect with the processing device 218 when the processing device 218 is located within the mounting portion structure cavity 216 such that the processing device 218 and the sensing device 326 are in electrical/signal communication. Accordingly, when the processing device 218 is located within the mounting portion structure cavity 216 and a user engages the at least one sensor button/touch area 334, the sensing device 326 emits laser light from the sensor opening 330. When the laser light contacts a barcode, the sensing device 326 ‘senses’ the barcode, obtains information from the barcode and communicates the information from the barcode to the processing device 218.

It should be appreciated that the device scanning portion 204 may be connected to the device mounting portion 202 via screws and/or any other device and/or method suitable to the desired end purpose. Referring again to FIG. 15, the device scanning portion 204 is connected to the device mounting portion 202 via a mounting plate 350 which is used secured to the scanning device body cover 304 via screws 352. It should be appreciated that in one embodiment, the device scanning portion 204 may be connected to the device mounting portion 202 in a width wise (or horizontal) fashion relative to the device mounting portion 202, while in another embodiment, the device scanning portion 204 may be connected to the device mounting portion 202 in a length wise (or vertical) fashion relative to the device mounting portion 202. Moreover, it is contemplated that the device scanning portion 204 may be rotatably connected to the device mounting portion 202 via a rotatable mount, such as a swivel connector which allows the device scanning portion 204 to rotate about an axis relative to the device mounting portion 202. Moreover, it is further contemplated that the device scanning portion 204 further includes a retaining strap 354 which may be non-movably connected to the device scanning portion 204 or rotatably connected to the device scanning portion 204 via a rotatable mount, such as a swivel connector which allows the retaining strap 354 to rotate about an axis relative to the device scanning portion 204.

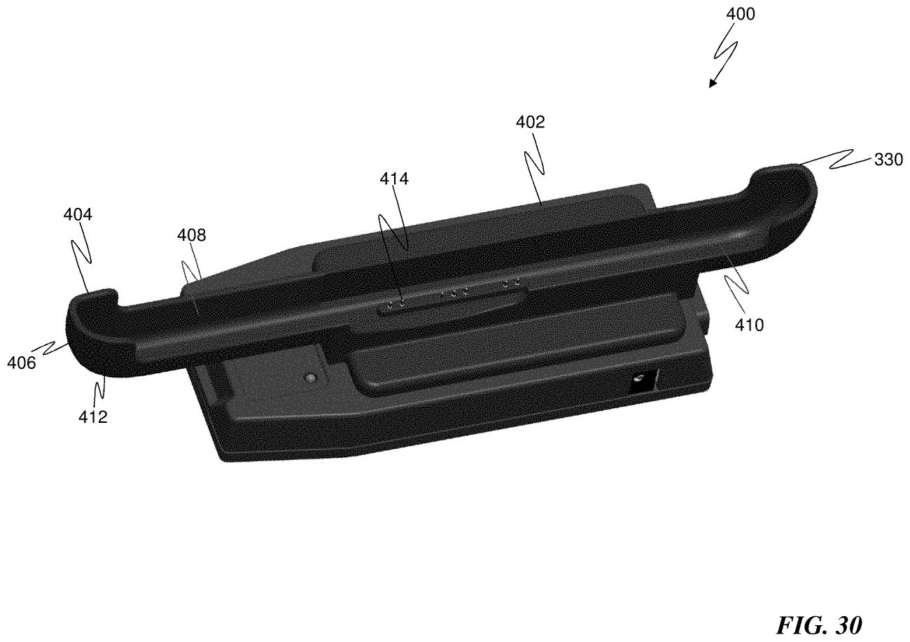

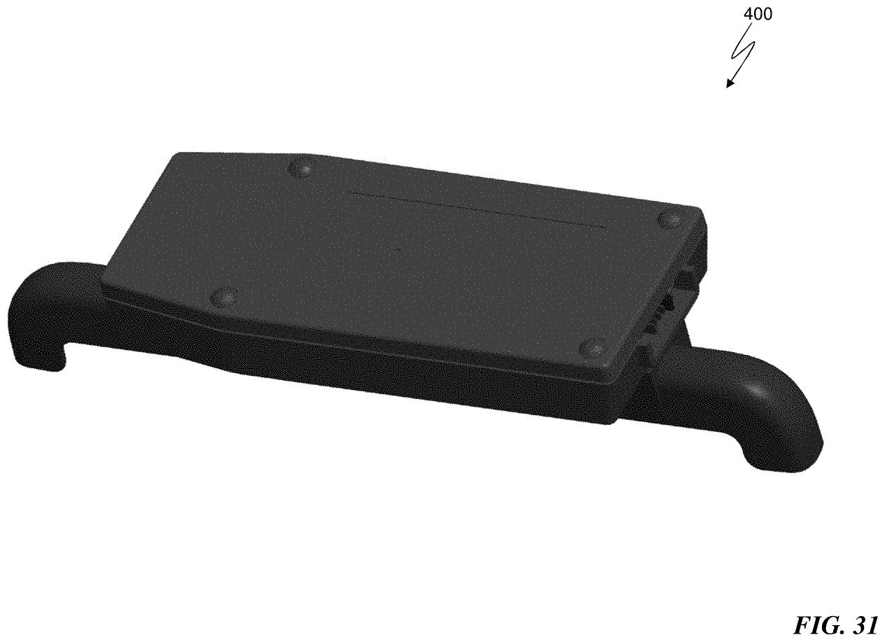

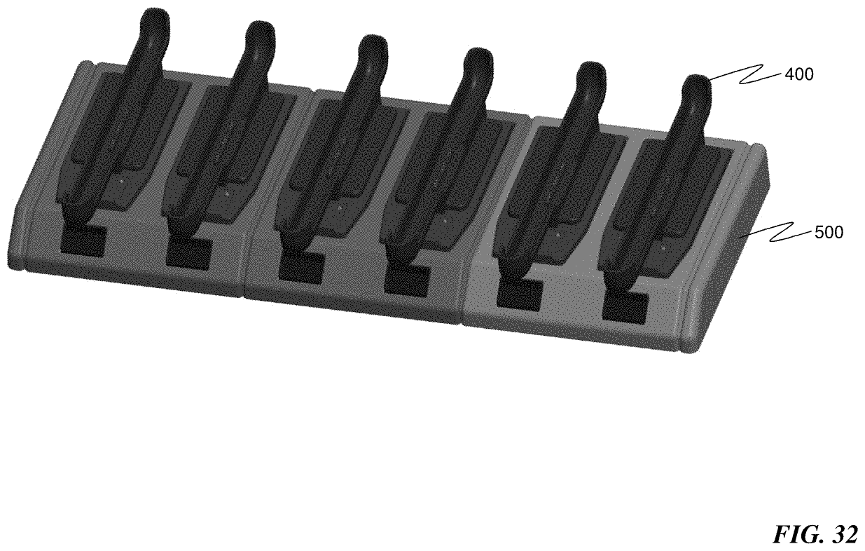

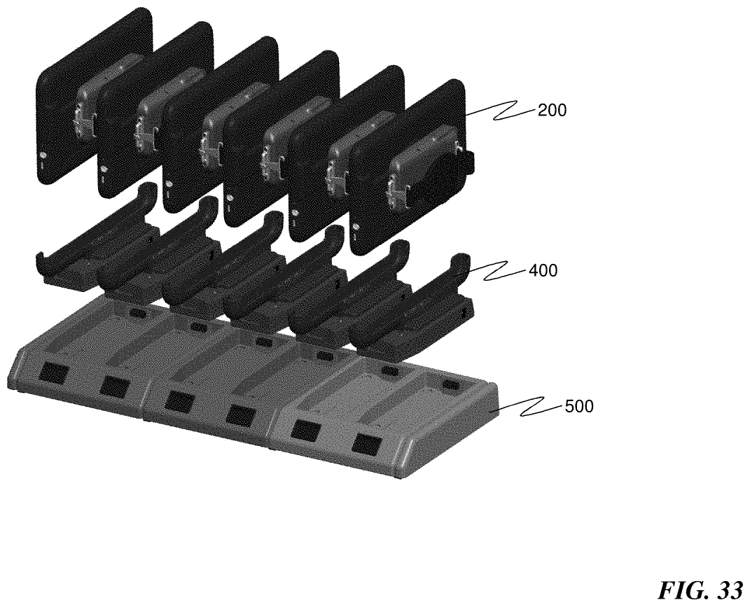

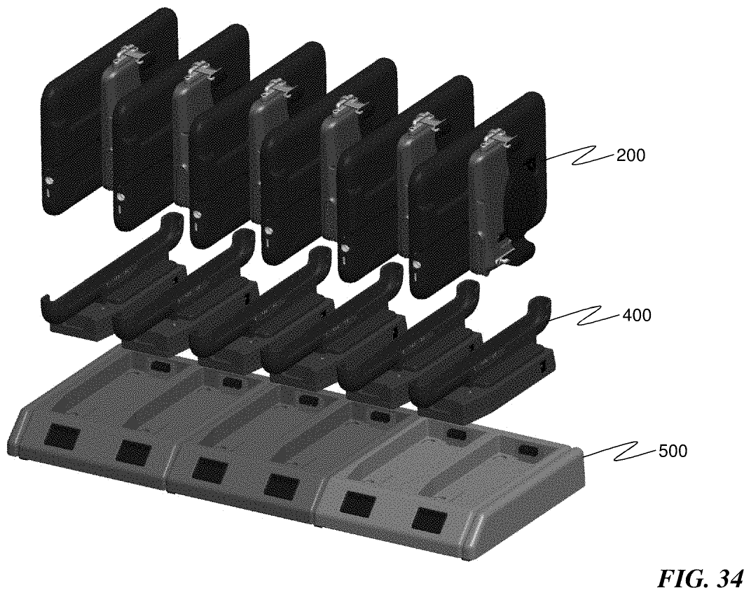

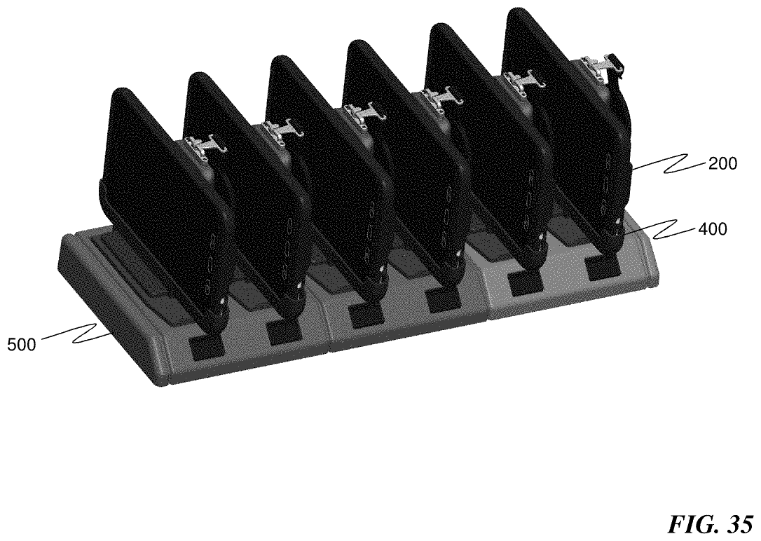

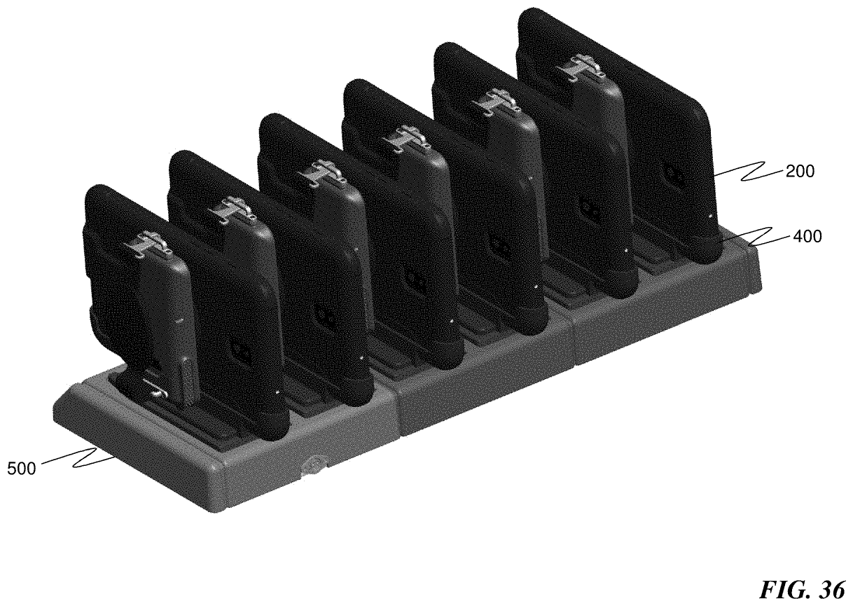

Referring to FIGS. 30-36 a docking structure 400 and a nesting structure 500 is provided, in accordance with one embodiment of the invention. The docking structure 400 includes a structure base 402 and a device cradle 404, wherein the device cradle 404 includes a cradle structure 406 which defines a cradle cavity 408 for containing a barcode scanning device 200. The cradle structure 406 includes a cradle bottom 410 and cradle sides 412 which are configured to allow the barcode scanning device 200 to be securely contained within the cradle cavity 408. The cradle structure 406 also includes one or more device connector pins 414 which protrude up from the cradle bottom 410 and into the cradle cavity 408. It should be appreciated that the structure base 402 includes processing electronics for communicating with the processing device 218 when the barcode scanning device 200 is contained within the cradle cavity 408, wherein the processing electronics are connected to the device connector pins 414. It should be further appreciated that the processing device 218 includes processing device side connectors 226, 416 which allow external devices to programmably interact with another processing device, such as a standalone computer. Accordingly, when the barcode scanning device 200 is located within the cradle cavity 408, the device connector pins 414 are in contact with the processing device side connectors 416. This advantageously allows the structure base 402 (or a processing device connected to the structure base 402) to communicate with the processing device 218. It should be appreciated that the docking structure 400 may one docking structure 400 or a plurality of docking structures 400, as desired.

The nesting structure 500 allows for a plurality of docking structures 400 to be nested together and communicated with a host processing device that is communicated with the structure base 402 for download of information and for gang or group charging/programming of the processing devices 116, 218. Additionally, it should be appreciated that the processing devices 116, 218 may be communicated with the host processing device (i.e. via a secured hardwired and/ or wireless communication). Accordingly, information may be uploaded/downloaded to/from the processing devices 116, 218 via a hardwired/wireless connection if desired.

It should be further appreciated that the barcode scanning device 100, 200 may be constructed from any material suitable to the desired end purpose, such as a composite material and/or a thermoplastic material, such as polypropylene or high-density polyethylene.

While the invention has been described with reference to an exemplary embodiment, it should be understood by those skilled in the art that various changes may be made and equivalents may be substituted for elements thereof without departing from the scope of the invention. Moreover, the embodiments or parts of the embodiments may be combined in whole or in part without departing from the scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A barcode scanning device, comprising:
a device mounting article having a mounting front portion and a mounting rear portion, wherein the mounting front portion and mounting rear portion define a device cavity for securely containing a portable processing device; and
a device scanning article, wherein the device scanning a article defines a sensor cavity and includes,
a sensing device,
a sensor opening,
a transmitter,
a receiver,
an activation button,
a BCS processing device, and
at least one capacitive touch sensor configured to sense when the device scanning article is being touched by a user,
wherein when the activation button is engaged and the at least one capacitive touch sensor senses that the device scanning article is being touched by a user, the device scanning article is configured to optically interact with a barcode having barcode information to obtain the barcode information and communicate the barcode information to the portable processing device.

2. The barcode scanning device of claim 1, wherein the at least one capacitive touch sensor includes a plurality of capacitive touch sensors.

3. The barcode scanning device of claim 2, wherein the plurality of capacitive touch sensors are located within the device cavity to be proximate the periphery side wall of the device mounting article.

4. The barcode scanning device of claim 1, wherein the device scanning article optically interacts with the barcode by emitting laser light out of the sensor opening to illuminate the barcode and generate reflected laser light.

5. The barcode scanning device of claim 4, wherein the device scanning article optically interacts with the barcode by receiving the reflected laser light via the sensor opening and communicating the reflected laser light to the BCS processing device.

6. The barcode scanning device of claim 5, wherein the BCS processing device processes the reflected laser light to identify the barcode information and communicates the barcode information to the portable processing device.

7. The barcode scanning device of claim 1, wherein the portable processing device includes at least one of a smart phone, a tablet, an iPhone®, an iPad®, an iPod® Touch and laptop computing device.

8. The barcode scanning device of claim 1, wherein the device mounting article is at least partially constructed from at least one of a rigid material, a semi-rigid material and/or a flexible material.

9. The barcode scanning device of claim 8, wherein the rigid material, semi-rigid material and/or the flexible material includes a plastic material, a rubber material, a metal material, a composite material and/or a combination thereof.

10. A barcode scanning device, comprising:
a device mounting article which defines a device cavity for securely containing a portable processing device; and
a device scanning article, wherein the device scanning article is communicated with the portable processing device and includes,
an activation button, and
at least one capacitive touch sensor configured to sense when the device scanning article is being touched by a user, wherein when the activation button is engaged and the at least one capacitive touch sensor senses that the device scanning article is being touched by a user, the device scanning article is configured to optically interact with a barcode to obtain barcode information and communicate the barcode information to the portable processing device.

11. The barcode scanning device of claim 10, wherein the at least one capacitive touch sensor includes a plurality of capacitive touch sensors.

12. The barcode scanning device of claim 11, wherein the plurality of capacitive touch sensors are located within the device cavity to be proximate the periphery side wall of the device mounting article.

13. The barcode scanning device of claim 10, wherein the device scanning article optically interacts with the barcode by emitting laser light out of the sensor opening to illuminate the barcode and generate reflected laser light.

14. The barcode scanning device of claim 13, wherein the device scanning article further includes a BCS processing device and optically interacts with the barcode by receiving the reflected laser light via the sensor opening and communicating the reflected laser light to the BCS processing device.

15. The barcode scanning device of claim 14, wherein the BCS processing device processes the reflected laser light to identify the barcode information and communicates the barcode information to the portable processing device.

16. The barcode scanning device of claim 10, wherein the portable processing device includes at least one of a smart phone, a tablet, an iPhone®, an iPad®, an iPod® Touch and laptop computing device.

17. The barcode scanning device of claim 10, wherein the device mounting article is at least partially constructed from at least one of a rigid material, a semi-rigid material and/or a flexible material.

18. The barcode scanning device of claim 17, wherein the rigid material, semi-rigid material and/or the flexible material includes a plastic material, a rubber material, a metal material, a composite material and/or a combination thereof.

19. A method for implementing a barcode scanning device, wherein the barcode scanning device includes an activation button and at least one capacitive touch sensor configured to sense when the device scanning article is being touched by a user and wherein the barcode scanning device is configured to operate only when the activation button is engaged and when the at least one capacitive touch sensor senses that the device scanning article is being touched by the user, the method comprising:
associating a portable processing device with the barcode scanning device;
handling the portable processing device to cause the capacitive touch sensor to sense the user; and
engaging the activation button to cause the barcode scanning device to sense a barcode having barcode information and to obtain the barcode information; and
communicating the barcode information to the portable processing device.

20. The method of claim 19, wherein sensing a barcode to obtain barcode information includes,
optically illuminating the barcode using laser light,
receiving reflected laser light from the barcode, and
processing the reflected laser light to identify the barcode information.
